(19) United States
(12) Patent Application Publication
(10) Pub. No.: US 2020/0278376 A1
(43) Pub. Date: Sep. 3, 2020

(54) INERTIAL SENSOR, ELECTRONIC APPARATUS, AND VEHICLE

(71) Applicant: SEIKO EPSON CORPORATION, Tokyo (JP)

(72) Inventor: Kazuyuki NAGATA, MINOWA-MACHI (JP)

(21) Appl. No.: 16/800,638

(22) Filed: Feb. 25, 2020

(30) Foreign Application Priority Data
Feb. 28, 2019 (JP) 2019-036532

(51) Int. Cl. G01P 15/125; G01P 15/18

(52) U.S. Cl. CPC G01P 15/125; G01C 21/16; G01P 15/18

(57) ABSTRACT

An inertial sensor includes a package that includes a substrate and a lid bonded to the substrate and has an internal space between the substrate and the lid and a sensor element accommodated in the internal space, and in which the lid has a through-hole causing an inside and an outside of the internal space to communicate with each other and sealed with a sealing member and the inertial sensor further includes a cylindrical first projection portion provided on the lid and surrounding an opening of the through-hole on the internal space side in plan view and a cylindrical second projection portion provided on the substrate and surrounding an outer periphery of the first projection portion in plan view.

The present application is based on, and claims priority from JP Application Serial Number 2019-036532, filed Feb. 28, 2019, the disclosure of which is hereby incorporated by reference herein in its entirety.

### BACKGROUND

### 1. Technical Field

The present disclosure relates to an inertial sensor, an electronic apparatus, and a vehicle.

### 2. Related Art

In JP-A-2013-164301, an inertial sensor including a substrate, a sensor element provided on the substrate, and a lid bonded to the substrate 2 so as to cover the sensor element is described. In the lid, a through-hole that communicates with the inside and outside of an internal space in which the sensor element is accommodated is formed, and the internal space can be brought into a desired atmosphere via the through-hole. As such, after making internal space into a desired atmosphere via the through-hole, the through-hole is sealed with a sealing member.

However, in the inertial sensor of JP-A-2013-164301, the through-hole is positioned immediately above the sensor element. For that reason, when the through-hole is sealed with the sealing member, the sealing member passes through the through-hole and adheres to the sensor element as it is, which may affect the drive characteristics of the sensor element.

### SUMMARY

An inertial sensor according to an aspect of the disclosure includes a package that includes a substrate and a lid bonded to the substrate and has an internal space between the substrate and the lid, and a sensor element accommodated in the internal space, in which the lid has a through-hole causing an inside and an outside of the internal space to communicate with each other and sealed with a sealing member, and the inertial sensor further includes a cylindrical first projection portion provided on the lid and surrounding an opening of the through-hole on the internal space side in plan view, and a cylindrical second projection portion provided on the substrate and surrounding an outer periphery of the first projection portion in plan view.

### BRIEF DESCRIPTION OF THE DRAWINGS

FIG. 1 is a plan view illustrating an inertial sensor according to a first embodiment.

FIG. 2 is a cross-sectional view taken along line II-II in FIG. 1.

FIG. 3 is a plan view illustrating an example of a sensor element that measures acceleration in the X-axis direction.

FIG. 4 is a plan view illustrating an example of a sensor element that measures acceleration in the Y-axis direction.

FIG. 5 is a plan view illustrating an example of a sensor element that measures acceleration in the Z-axis direction.

FIG. 6 is a graph illustrating an example of a drive voltage applied to each sensor element.

FIG. 7 is a cross-sectional view illustrating a region Q in FIG. 2.

FIG. 8 is a cross-sectional view of a foreign matter adhesion suppression unit illustrated in FIG. 7.

FIG. 9 is a cross-sectional view illustrating a modification example of the foreign matter adhesion suppression unit illustrated in FIG. 7.

FIG. 10 is a cross-sectional view illustrating another modification example of the foreign matter adhesion suppression unit illustrated in FIG. 7.

FIG. 11 is a cross-sectional view illustrating another modification example of the foreign matter adhesion suppression unit illustrated in FIG. 7.

FIG. 12 is a cross-sectional view illustrating another modification example of the foreign matter adhesion suppression unit illustrated in FIG. 7.

FIG. 13 is a cross-sectional view illustrating another modification example of the foreign matter adhesion suppression unit illustrated in FIG. 7.

FIG. 14 is a cross-sectional view illustrating a foreign matter adhesion suppression unit included in an inertial sensor of a second embodiment.

FIG. 15 is a cross-sectional view illustrating a foreign matter adhesion suppression unit included in an inertial sensor of a third embodiment.

FIG. 16 is a plan view illustrating an inertial sensor of a fourth embodiment.

FIG. 17 is a plan view illustrating a smartphone according to a fifth embodiment.

FIG. 18 is an exploded perspective view illustrating an inertial measurement device according to a sixth embodiment.

FIG. 19 is a perspective view of a substrate included in the inertial measurement device illustrated in FIG. 18.

FIG. 20 is a block diagram illustrating an entire system of a vehicle positioning device according to a seventh embodiment.

FIG. 21 is a diagram illustrating an operation of the vehicle positioning device illustrated in FIG. 20.

FIG. 22 is a perspective view illustrating a vehicle according to an eighth embodiment.

### DESCRIPTION OF EXEMPLARY EMBODIMENTS

Hereinafter, an inertial sensor, an electronic apparatus, and a vehicle according to the present disclosure will be described in detail based on embodiments illustrated in the accompanying drawings.

### First Embodiment

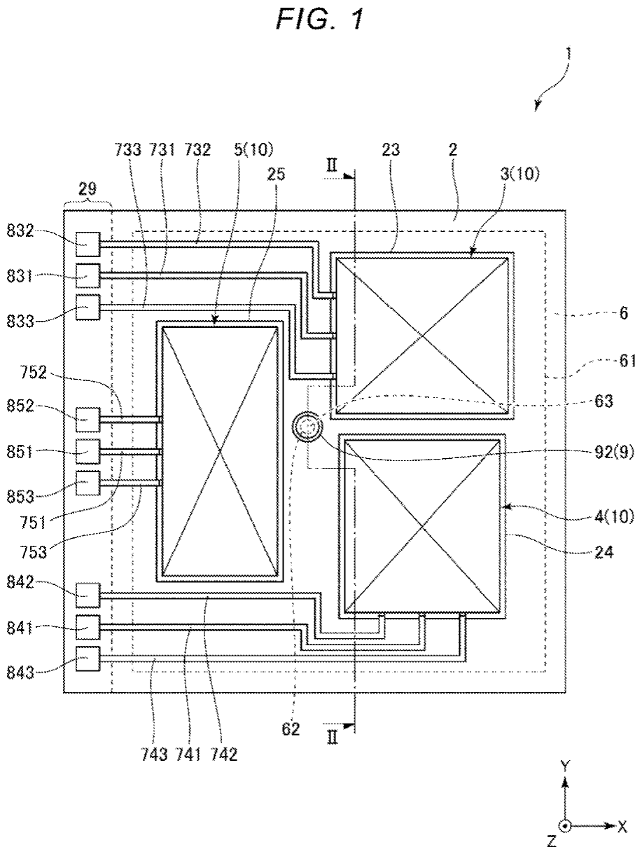

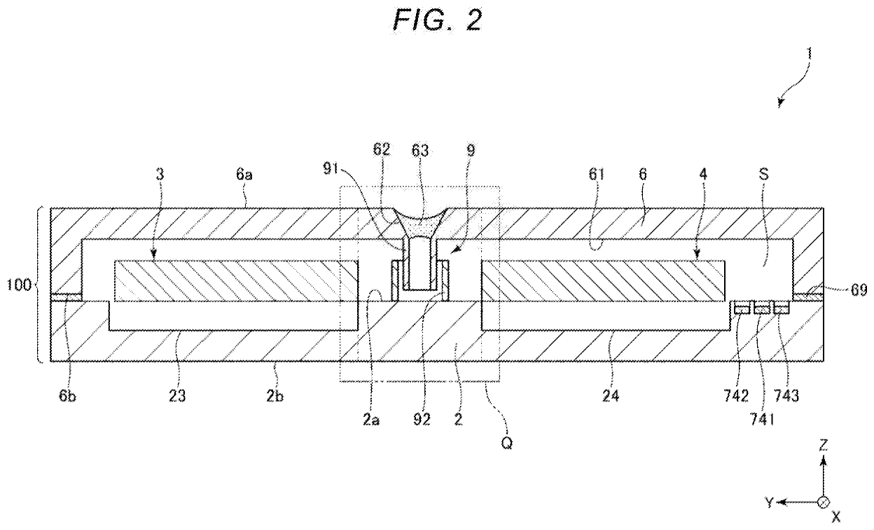

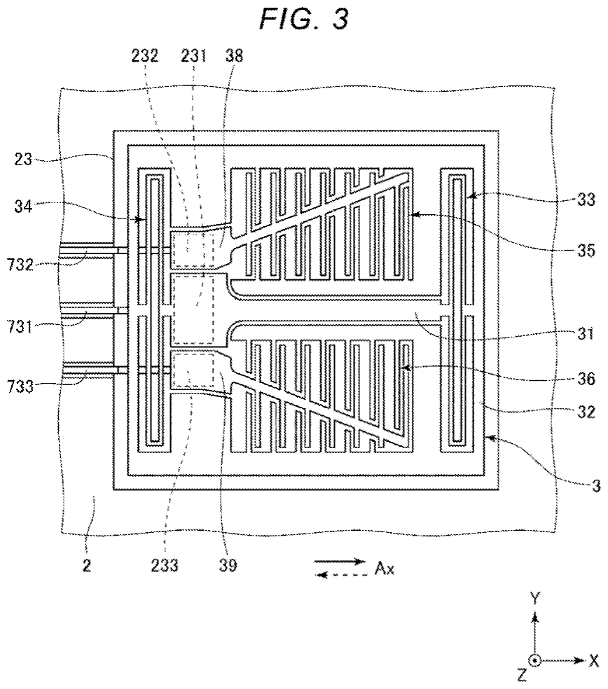

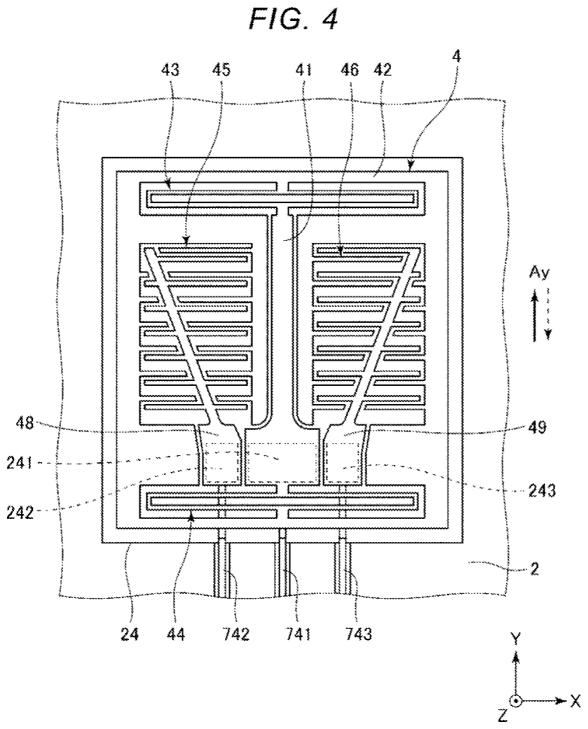

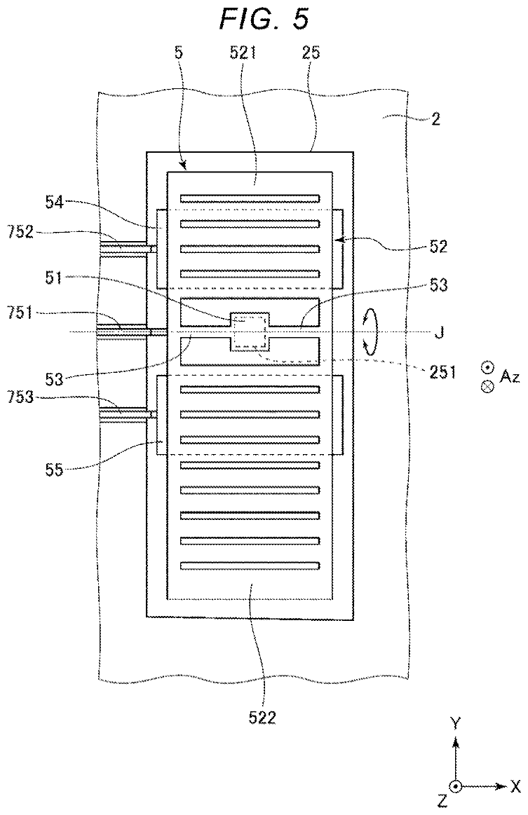

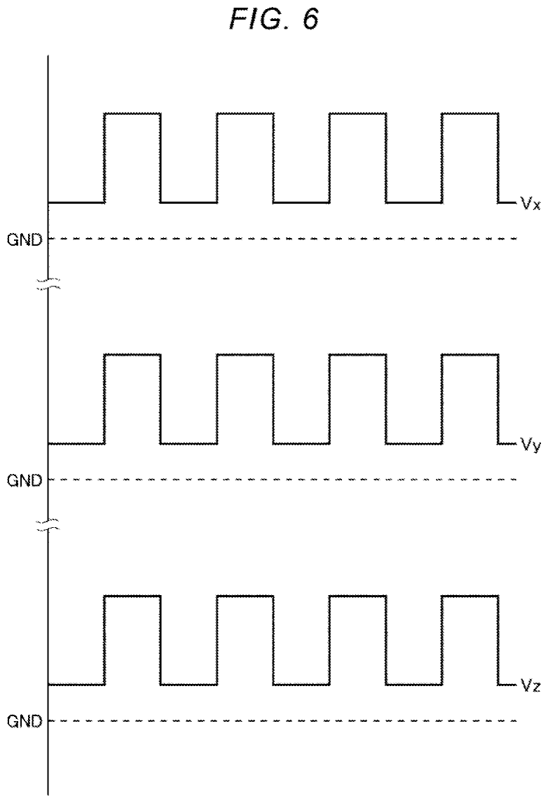

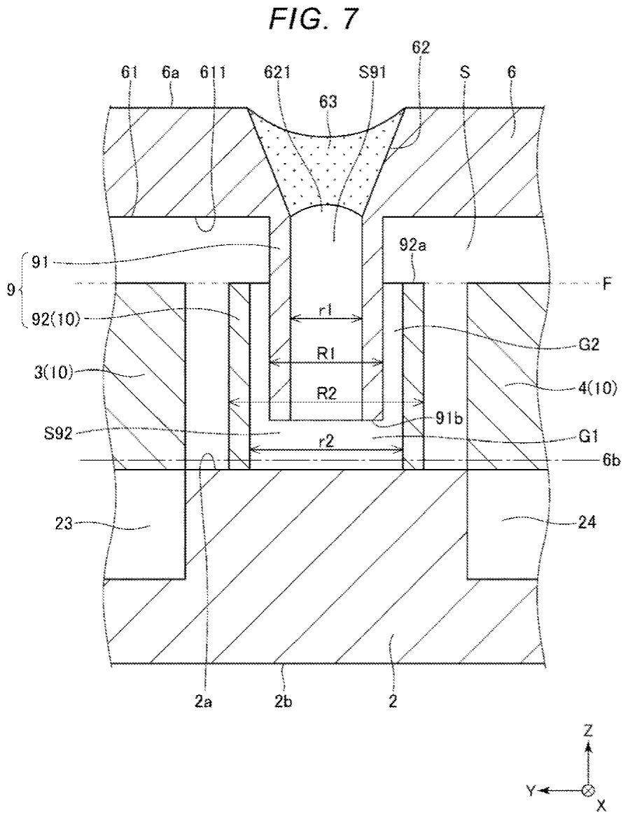

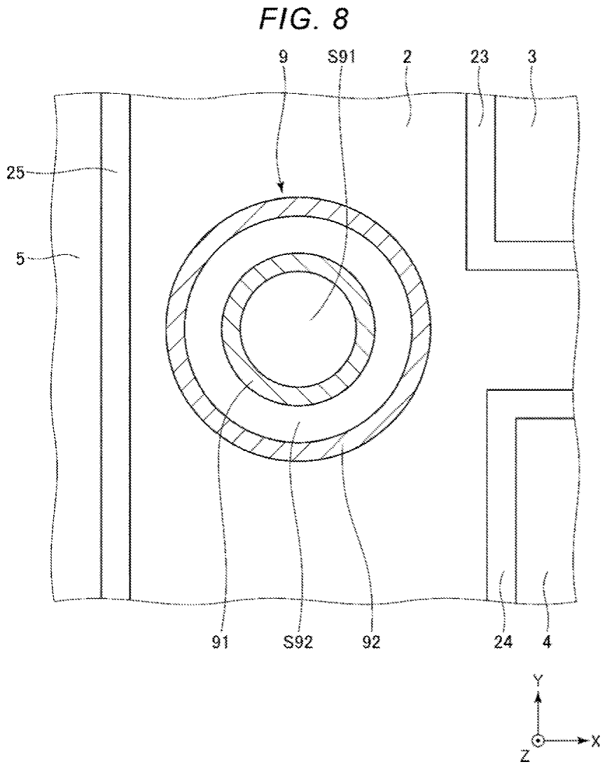

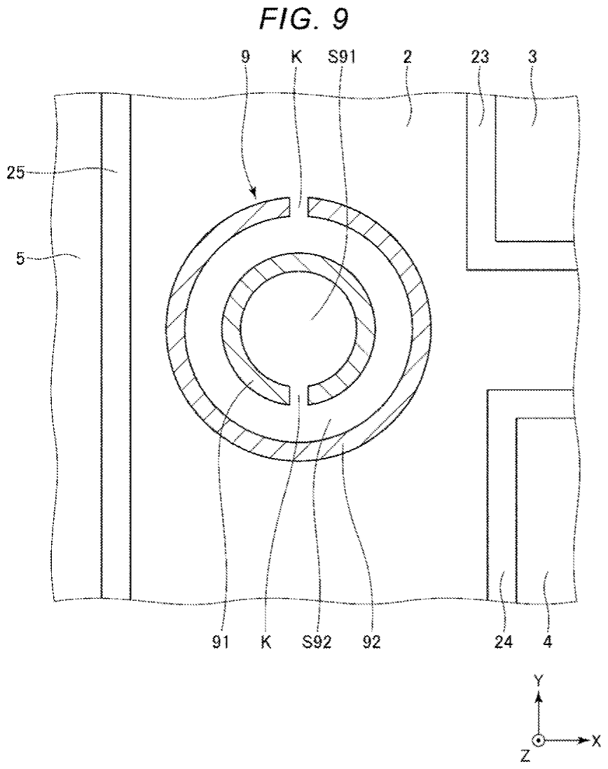

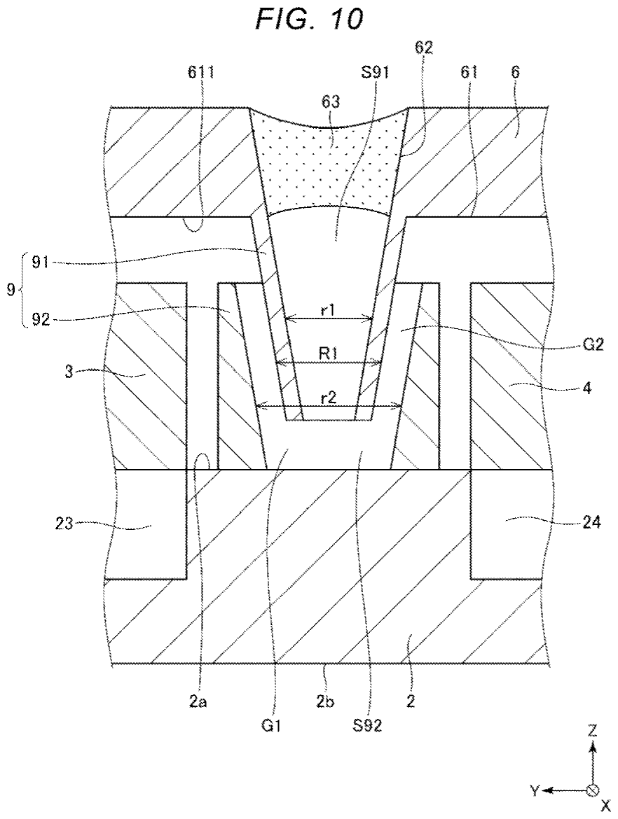

FIG. 1 is a plan view illustrating an inertial sensor according to a first embodiment. FIG. 2 is a cross-sectional view taken along line II-II in FIG. 1. FIG. 3 is a plan view illustrating an example of a sensor element that measures acceleration in the X-axis direction. FIG. 4 is a plan view illustrating an example of a sensor element that measures acceleration in the Y-axis direction. FIG. 5 is a plan view illustrating an example of a sensor element that measures acceleration in the Z-axis direction. FIG. 6 is a graph illustrating an example of a drive voltage applied to each sensor element. FIG. 7 is a cross-sectional view illustrating a region Q in FIG. 2. FIG. 8 is a cross-sectional view of a foreign matter adhesion suppression unit illustrated in FIG. 7. FIG. 9 is a cross-sectional view illustrating a modification example of the foreign matter adhesion suppression unit illustrated in FIG. 7. FIGS. 10 to 13 are cross-sectional views illustrating modification examples of the foreign matter adhesion suppression unit illustrated in FIG. 7.

In each drawing, the X-axis, Y-axis, and Z-axis are illustrated as three axes orthogonal to each other. A direction along the X-axis, that is, a direction parallel to the X-axis is referred to as an “X-axis direction”, a direction along the Y-axis is referred as a “Y-axis direction”, and a direction along the Z-axis is referred as a “Z-axis direction”. A tip end side of the arrow of each axis is also referred to as a “plus side”, and the opposite side is also referred to as a “minus side”. In addition, the plus side in the Z-axis direction is also referred to as “upper”, and the minus side in the Z-axis direction is also referred to as “lower”.

The inertial sensor 1 illustrated in FIG. 1 is an acceleration sensor that can independently measure accelerations in the X-axis direction, the Y-axis direction, and the Z-axis direction that are orthogonal to each other. Such an inertial sensor 1 includes a substrate 2, three sensor elements 3, 4, and 5 disposed on the substrate 2, and a lid 6 that accommodates the sensor elements 3, 4, and 5 and is bonded to the substrate 2. Among the three sensor elements 3, 4, and 5, the sensor element 3 measures the acceleration Ax in the X-axis direction, the sensor element 4 measures the acceleration Ay in the Y-axis direction, and the sensor element 5 detects an acceleration Az in the Z-axis direction. In FIG. 1, for convenience of explanation, the sensor elements 3, 4, and 5 are illustrated in a simplified manner.

A configuration of the inertial sensor 1 is not limited to the configuration described above, and, for example, an arrangement, shape, function, and the like of the sensor elements 3, 4, and 5 may be different from the illustrated configuration. For example, one or two of the sensor elements 3, 4, and 5 may be omitted. A sensor element that can measure the angular velocity may be used instead of or in addition to the sensor elements 3, 4, and 5.

As illustrated in FIGS. 1 and 2, the substrate 2 has a plate shape having an upper surface 2a and a lower surface 2b that are in a front-back relationship, and includes three concave portions 23, 24, and 25 that open to the upper surface 2a. The sensor element 3 is disposed so as to overlap the concave portion 23, the sensor element 4 is disposed so as to overlap the concave portion 24, and the sensor element 5 is disposed so as to overlap the concave portion 25. These concave portions 23, 24, and 25 suppress contact between the sensor elements 3, 4, and 5 and the substrate 2.

As such a substrate 2, for example, a glass substrate made of a glass material containing alkali metal ions such as sodium ions, specifically, borosilicate glass such as Tempax glass and Pyrex glass (both registered trademark) can be used. However, a constituent material of the substrate 2 is not particularly limited, and a silicon substrate, a ceramic substrate, and the like may be used.

As illustrated in FIG. 2, the lid 6 has a plate shape having an upper surface 6a and a lower surface 6b that are in a front-back relationship, and includes a concave portion 61 that opens to the lower surface 6b. The lid 6 accommodates the sensor elements 3, 4, and 5 in concave portion 61 formed inside thereof, and is bonded to the upper surface 2a of the substrate 2. The lid 6 and the substrate 2 constitute a package 100 having an internal space S that airtightly accommodates the sensor elements 3, 4, and 5.

The lid 6 is provided with a through-hole 62 that communicates the inside and outside of the internal space S and the internal space S can be replaced with a desired atmosphere via the through-hole 62. After the internal space S is made to have a desired atmosphere through the through-hole 62, the through-hole 62 is sealed with a sealing member 63. The through-hole 62 is provided so as not to overlap the sensor elements 3, 4, and 5 in plan view from the Z-axis direction. In the first embodiment, the sealing member 63 is made of silicon oxide (SiO₂) and is formed by a CVD method using tetraethoxysilane (TEOS). However, the constituent material of the sealing member 63 is not particularly limited, and for example, silicon nitride, various metal materials, and the like can be used. Further, the method for forming the sealing member 63 is not particularly limited, and for example, the sealing member 63 can be formed by sputtering. For example, the through-hole 62 may be sealed by irradiating a metal ball disposed in the through-hole 62 with laser light to melt and solidify the metal ball.

In such a configuration, when the through-hole 62 is sealed with the sealing member 63, a part of the sealing member 63 may pass through the through-hole 62, enter the internal space S, and adhere to the sensor elements 3, 4, and 5. Since adhesion of the sealing member 63 to the sensor elements 3, 4, and 5 causes the drive characteristics of the sensor elements 3, 4, and 5 to deteriorate and vary, in the inertial sensor 1, a foreign matter adhesion suppression unit 9 that suppresses the adhesion of the sealing member 63 that entered the internal space S to the sensor elements 3, 4, and 5 is provided. With this configuration, it is possible to suppress deterioration or variation in the drive characteristics of the sensor elements 3, 4, and 5. The foreign matter adhesion suppression unit 9 will be described in detail later.

The internal space S may be filled with inert gas such as nitrogen, helium, or argon, and may be at approximately atmospheric pressure at an operating temperature (for example, approximately −40° C. to 80° C.). By setting the internal space S to atmospheric pressure, viscous resistance is increased and a damping effect is exhibited, so that vibrations of the sensor elements 3, 4, and 5 can be quickly converged. For that reason, a detection accuracy of the inertial sensor 1 is improved.

As such a lid 6, for example, a silicon substrate can be used. However, the lid 6 is not particularly limited, and for example, a glass substrate or a ceramic substrate may be used as the lid 6. Although a bonding method between the substrate 2 and the lid 6 is not particularly limited and may be appropriately selected depending on the materials of the substrate 2 and the lid 6, in the first embodiment, the substrate 2 and the lid 6 are bonded by a bonding member 69 formed over the circumference of the lower surface of the lid 6. As the bonding member 69, for example, a glass frit material which is low melting point glass can be used.

As illustrated in FIG. 1, the lid 6 is disposed so as to be biased toward the plus side in the X-axis direction, which is the first direction of the substrate 2, and a portion of the substrate 2 at the minus side in the X-axis direction is exposed from the lid 6. Hereinafter, this exposed portion is also referred to as an “exposed portion 29”.

The substrate 2 has a groove which opens to the upper surface 2a thereof, and a plurality of wirings 731, 732, 733, 741, 742, 743, 751, 752, and 753 and terminals 831, 832, 833, 841, 842, 843, 851, 852, and 853 are disposed in the groove. The wirings 731, 732, 733, 741, 742, 743, 751, 752, and 753 are disposed inside and outside of the internal space S. Among these wirings, the wirings 731, 732, and 733 are electrically coupled to the sensor element 3, the wirings 741, 742, and 743 are electrically coupled to the sensor element 4, and the wirings 751, 752, and 753 are electrically coupled to the sensor element 5.

The terminals 831, 832, 833, 841, 842, 843, 851, 852, and 853 are respectively disposed on the exposed portion 29. Then, the terminal 831 is electrically coupled to the wiring 731, the terminal 832 is electrically coupled to the wiring 732, the terminal 833 is electrically coupled to the wiring 733, the terminal 841 is electrically coupled to the wiring 741, the terminal 842 is electrically coupled to the wiring 742, the terminal 843 is electrically coupled to the wiring 743, the terminal 851 is electrically coupled to the wiring 751, the terminal 852 is electrically coupled to the wiring 752, and the terminal 853 is electrically coupled to the wiring 753.

Next, the sensor elements 3 to 5 will be described with reference to FIGS. 3 to 5. The sensor elements 3, 4, and 5 can be collectively formed by, for example, anodically bonding a silicon substrate 10 doped with impurities such as phosphorus (P), boron (B), and arsenic (As) to the upper surface of the substrate 2 and patterning the silicon substrate by a Bosch process that is a deep groove etching technique. However, the method of forming the sensor elements 3, 4, and 5 is not limited thereto.

The sensor element 3 can measure the acceleration Ax in the X-axis direction. As such a sensor element 3, for example, as illustrated in FIG. 3, the sensor element 3 includes a fixed portion 31 fixed to a mount 231 protruding from the bottom surface of the concave portion 23, a movable body 32 displaceable in the X-axis direction with respect to the fixed portion 31, springs 33 and 34 coupling the fixed portion 31 and the movable body 32, a first movable electrode 35 and a second movable electrode 36 provided in the movable body 32, a first fixed electrode 38 fixed to amount 232 protruding from the bottom surface of the concave portion 23 and facing the first movable electrode 35, and a second fixed electrode 39 fixed to amount 233 protruding from the bottom surface of the concave portion 23 and facing the second movable electrode 36.

The first and second movable electrodes 35 and 36 are electrically coupled to the wiring 731 in the fixed portion 31, the first fixed electrode 38 is electrically coupled to the wiring 732, and the second fixed electrode 39 is electrically coupled to the wiring 733. Then, for example, a drive voltage Vx in which a DC voltage and an AC voltage as illustrated in FIG. 6 are superimposed is applied to the first and second movable electrodes 35 and 36 through the terminal 831. On the other hand, the first and second fixed electrodes 38 and 39 are coupled to a charge amplifier through the terminals 832 and 833. For that reason, capacitance Cx1 is formed between the first movable electrode 35 and the first fixed electrode 38 and capacitance Cx2 is formed between the second movable electrode 36 and the second fixed electrode 39.

Then, when the acceleration Ax is applied to the sensor element 3 in a state where the capacitances Cx1 and Cx2 are formed, the movable body 32 is displaced in the X-axis direction, and accordingly, the capacitances Cx1 and Cx2 change in opposite phases. For that reason, the acceleration Ax received by the sensor element 3 can be obtained based on the change (differential operation) of the capacitances Cx1 and Cx2.

The sensor element 4 can measure the acceleration Ay in the Y-axis direction. Such a sensor element 4 is not particularly limited, but, for example, as illustrated in FIG. 4, can be configured by rotating the sensor element 3 described above by 90 degrees around the Z-axis. That is, the sensor element 4 includes a fixed portion 41 fixed to a mount 241 protruding from the bottom surface of the concave portion 24, a movable body 42 displaceable in the Y-axis direction with respect to the fixed portion 41, springs 43 and 44 coupling the fixed portion 41 and the movable body 42, a first movable electrode 45 and a second movable electrode 46 provided in the movable body 42, a first fixed electrode 48 fixed to a mount 242 protruding from the bottom surface of the concave portion 24 and facing the first movable electrode 45, and a second fixed electrode 49 fixed to a mount 243 protruding from the bottom surface of the concave portion 24 and facing the second movable electrode 46.

The first and second movable electrodes 45 and 46 are electrically coupled to the wiring 741 in the fixed portion 41, the first fixed electrode 48 is electrically coupled to the wiring 742, and the second fixed electrode 49 is electrically coupled to the wiring 743. Then, for example, a drive voltage Vy in which a DC voltage and an AC voltage as illustrated in FIG. 6 are superimposed is applied to the first and second movable electrodes 45 and 46 through the terminal 841. On the other hand, the first and second fixed electrodes 48 and 49 are coupled to the charge amplifier through the terminals 842 and 843. For that reason, capacitance Cy1 is formed between the first movable electrode 45 and the first fixed electrode 48 and capacitance Cy2 is formed between the second movable electrode 46 and the second fixed electrode 49.

Then, when the acceleration Ay is applied to the sensor element 4 in a state where the capacitances Cy1 and Cy2 are formed, the movable body 42 is displaced in the Y-axis direction, and accordingly, the capacitances Cy1 and Cy2 change in opposite phases. For that reason, the acceleration Ay received by the sensor element 4 can be obtained based on the changes (differential operation) of the capacitances Cy1 and Cy2.

The sensor element 5 can measure the acceleration Az in the Z-axis direction. Such a sensor element 5 is not particularly limited, but, for example, as illustrated in FIG. 5, includes a fixed portion 51 fixed to a mount 251 protruding from the bottom surface of the concave portion 25 and a movable body 52 that is coupled to the fixed portion 51 through a beam 53 and is swingable around a swing axis J along the X-axis with respect to the fixed portion 51. In the movable body 52, the first movable portion 521 positioned on one side of the swing shaft J and the second movable portion 522 positioned at the other side thereof have different rotational moments around the swing shaft J. The sensor element 5 is disposed on the bottom surface of the concave portion 25, and includes a first fixed electrode 54 disposed to face the first movable portion 521 and a second fixed electrode 55 disposed to face the second movable portion 522.

The movable body 52 is electrically coupled to the wiring 751 in the fixed portion 51, the first fixed electrode 54 is electrically coupled to the wiring 752, and the second fixed electrode 55 is electrically coupled to the wiring 753. Then, for example, a drive voltage Vz in which a DC voltage and an AC voltage as illustrated in FIG. 6 are superimposed is applied to the movable body 52 through the terminal 851. On the other hand, the first and second fixed electrodes 54 and 55 are coupled to the charge amplifier through the terminals 852 and 853. For that reason, capacitance Cz1 is formed between the first movable portion 521 and the first fixed electrode 54 and capacitance Cz2 is formed between the second movable portion 522 and the second fixed electrode 55.

Then, when the acceleration Az is applied to the sensor element 5 in a state where the capacitances Cz1 and Cz2 are formed, the movable body 52 is displaced around the swing axis J, and accordingly, the capacitances Cz1 and Cz2 change in opposite phases. For that reason, the acceleration Az received by the sensor element 5 can be obtained based on the changes (differential operation) of the capacitances Cz1 and Cz2.

The basic configuration of the inertial sensor 1 has been described as above. Next, the foreign matter adhesion suppression unit 9 will be described in detail. The foreign matter adhesion suppression unit 9 has a function of suppressing adhesion of the sealing member 63 that enters the internal space S to the sensor elements 3, 4, and 5.

As illustrated in FIG. 7, the foreign matter adhesion suppression unit 9 includes a cylindrical first projection portion 91 provided on the lid 6 and communicating with the through-hole 62 and a cylindrical second projection portion 92 provided on the substrate 2 and facing the first projection portion 91. Each of the first projection portion 91 and the second projection portion 92 is provided in the internal space S. The first projection portion 91 has a straight shape in which an inner diameter r1 and an outer diameter R1 are constant in the axial direction. Similarly, the second projection portion 92 also has a straight shape in which an inner diameter r2 and an outer diameter R2 are constant in the axial direction. As described above, since the through-hole 62 is provided so as not to overlap the sensor elements 3, 4, and 5, the first and second projection portions 91 and 92 can be easily provided.

The “cylindrical shape” is meant to include a semi-cylindrical shape in which a notch K extending in the axial direction is formed and which has a C-shaped cross section as illustrated in FIG. 9, in addition to a cross section of a cylindrical shape without an annular notch as in the first embodiment as illustrated in FIG. 8. In the case of the semi-cylindrical shape, the proportion of the notches K occupying the entire circumference may be as small as possible, specifically, the proportion is preferably 20% or less, more preferably 10% or less, and even more preferably 5% or less. When both the first projection portion 91 and the second projection portion 92 have the notch K, the notches K may be displaced in the circumferential direction so that the notches do not line up as illustrated in FIG. 9. With this configuration, it becomes difficult for the sealing member 63 to scatter from the notch K. The notch K of the second projection portion 92 may be positioned so as not to face the sensor elements 3, 4, and 5. With this configuration, even if the sealing member 63 scatters from the notch K, the scattering direction can deviate from the sensor elements 3, 4, and 5, and adhesion of the sealing member 63 to the sensor elements 3, 4, and 5 can be suppressed.

The first projection portion 91 is connected to the bottom surface 611 of the concave portion 61 at the upper end thereof, and protrudes from the bottom surface 611 toward the substrate 2 side, that is, toward the minus side in the Z-axis direction. The first projection portion 91 surrounds the entire circumference of a lower opening 621 and an inner space S91 communicates with the through-hole 62, in plan view from the Z-axis direction.

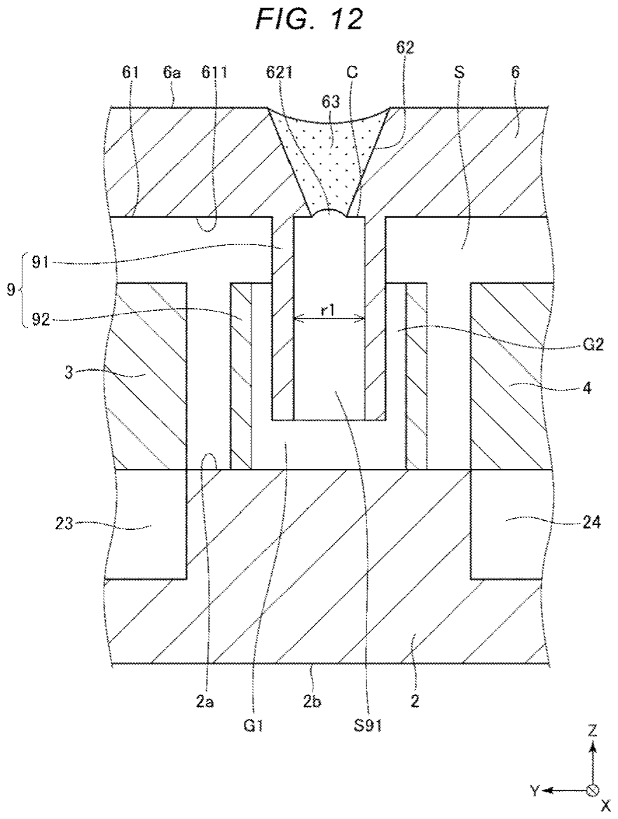

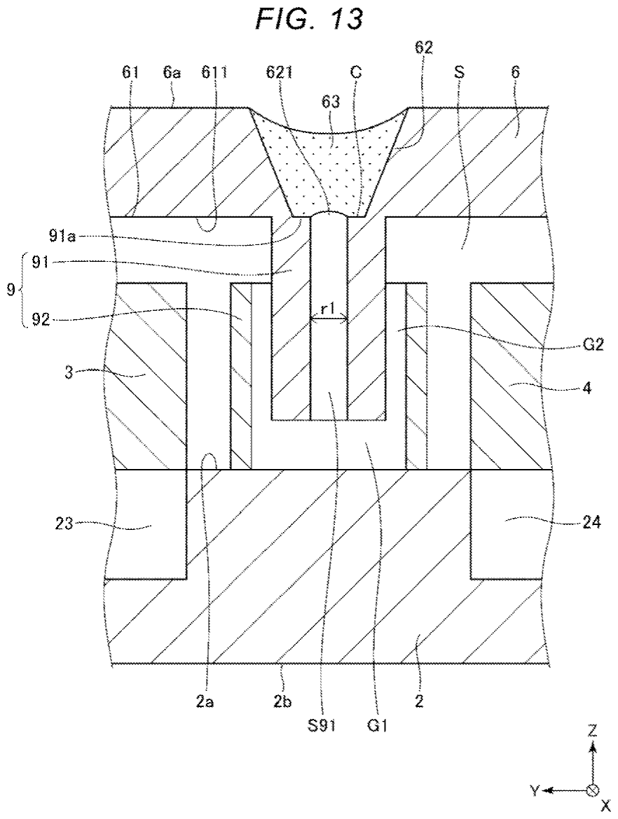

In the first embodiment, the inner peripheral surface of the through-hole 62 and the inner peripheral surface of the first projection portion 91 are continuous, but which is not limited thereto, for example, as illustrated in FIG. 12, the inner diameter r1 of the first projection portion 91 is larger than the diameter of the lower opening 621, and a step C formed by the bottom surface 611 between the inner peripheral surface of the through-hole 62 and the inner peripheral surface of the first projection portion 91 may be formed. As illustrated in FIG. 13, the inner diameter r1 of the first projection portion 91 is smaller than the diameter of the lower opening 621, and the step C configured by an upper end surface 91a of the first projection portion 91 may be formed between the inner peripheral surface of the through-hole 62 and the inner peripheral surface of the first projection portion 91.

When the X-Y plane on which the upper surfaces of the sensor elements 3, 4, and 5 are positioned is a “plane F”, the lower end surface 91b of the first projection portion 91 is positioned between the plane F and the lower surface 6b of the lid 6. According to such a configuration, a gap G1 can be formed between the first projection portion 91 and the substrate 2, and the internal space S can be replaced with a desired atmosphere via the through-hole 62. The lower end surface 91b of the first projection portion 91 can be sufficiently brought close to the upper surface 2a of the substrate 2, and the gap G1 is sufficiently reduced. For that reason, scattering of the sealing member 63 outside the first projection portion 91 via the gap G1 can be effectively suppressed. However, the position of the lower end surface 91b of the first projection portion 91 is not particularly limited, and may be positioned above the plane F, that is, between the plane F and the bottom surface 611, for example.

The first projection portion 91 is formed integrally with the lid 6. With this configuration, formation of the first projection portion 91 becomes easy. By forming the first projection portion 91 integrally with the lid 6, there is no gap between the first projection portion 91 and the lid 6, and scattering of the sealing member 63 outside the first projection portion 91 from the gap can be effectively suppressed. For that reason, adhesion of the sealing member 63 that enters the internal space S to the sensor elements 3, 4, and 5 can be effectively suppressed. However, the first projection portion 91 may be formed separately from the lid 6 and bonded to the bottom surface 611 via a bonding member or the like.

On the other hand, the lower end of the second projection portion 92 is connected to the upper surface 2a of the substrate 2 and protrudes from the upper surface 2a toward the lid 6 side. The second projection portion 92 is provided so as to overlap the first projection portion 91 in plan view from the Z-axis direction, and surrounds the entire circumference of the first projection portion 91. The upper end surface 92a of the second projection portion 92 is positioned above the lower end surface 91b of the first projection portion 91, that is, at the plus side in the Z-axis direction, and the lower end portion of the first projection portion 91 is inserted into an inner space S92 of the second projection portion 92. By adopting such a configuration, the gap G1 between the lower end surface 91b and the upper surface 2a can be surrounded by the second projection portion 92 over the entire circumference thereof, and thus even if the sealing member 63 scatters outside the first projection portion 91 from the gap G1, further scattering of the sealing member 63 can be suppressed by the second projection portion 92 positioned on the outside of the first projection portion 91. That is, it is possible to effectively suppress the sealing member 63 from scattering outside the second projection portion 92, and as a result, adhesion of the sealing member 63 to the sensor elements 3, 4, and 5 can be effectively suppressed.

The outer diameter R1 of the first projection portion is smaller than the inner diameter r2 of the second projection portion 92, and a gap G2 is formed between the outer peripheral surface of the first projection portion 91 and the inner peripheral surface of the second projection portion 92. For that reason, the through-hole 62 and the internal space S communicate with each other via the gaps G1 and G2, and the internal space S can be set to a desired atmosphere via the through-hole 62. Here, R1/r2 is not particularly limited, however, for example, 0.7≤R1/r2≤0.95 is preferable, and 0.8≤R1/r2≤0.9 is more preferable. With this configuration, the gap G2 can be made sufficiently small while ensuring the size necessary for replacing the atmosphere of the internal space S via the through-hole 62. For that reason, it is possible to more effectively suppress the sealing member 63 from scattering outside the second projection portion 92.

The upper end surface 92a of the second projection portion 92 is flush with the plane F. With this configuration, the second projection portion 92 can be made sufficiently high. As described above, since the lower end surface 91b of the first projection portion 91 is positioned below the plane F, the first projection portion 91 can be inserted into the second projection portion 92 by making the upper end surface 92a of the second projection portion 92 flush with the plane F. However, the position of the upper end surface 92a of the second projection portion 92 is not particularly limited, and may be above or below the plane F.

The second projection portion 92 having such a configuration is made of the same material as that of the sensor elements 3, 4, and 5. In particular, in the first embodiment, the second projection portion 92 is formed from the silicon substrate 10 on which the sensor elements 3, 4, and 5 are formed. With this configuration, the second projection portion 92 and the sensor elements 3, 4, and 5 can be collectively formed from the silicon substrate 10, and thus the second projection portion 92 can be easily formed. Since a separate step for forming the second projection portion 92 is not necessary, the number of manufacturing steps of the inertial sensor 1 is not increased, and an increase in manufacturing cost of the inertial sensor 1 can be suppressed. In particular, as described above, by making the upper end surface 92a of the second projection portion 92 flush with the plane F, processing for adjusting the height of the second projection portion 92 is not required before or after etching by the Bosch process, and thus the second projection portion 92 can be formed more easily.

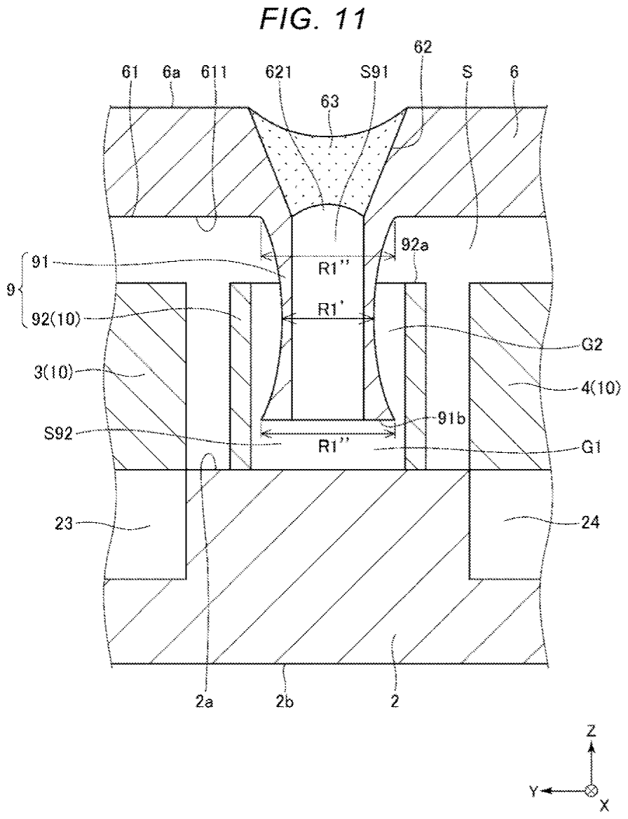

The shapes of the first projection portion 91 and the second projection portion 92 are not particularly limited, respectively, for example, the cross-sectional shapes thereof may be a polygon such as a triangle or a quadrangle, an oval, an irregular shape, or the like. The first projection portion 91 and the second projection portion 92 may have different cross-sectional shapes. As for the first projection portion 91 and the second projection portion 92, at least one of the inner diameter and the outer diameter thereof may change in the axial direction. For example, in the modification example illustrated in FIG. 10, the first projection portion 91 has a tapered shape in which the inner diameter r1 and the outer diameter R1 gradually decrease toward the substrate 2, and the second projection portion 92 has a tapered shape in which the inner diameter r2 gradually decreases toward the substrate 2 side. In particular, in the illustrated configuration, a taper angle of the inner peripheral surface of the first projection portion 91 is equal to the taper angle of the inner peripheral surface of the through-hole 62, and the taper angle of the inner peripheral surface of the second projection portion 92 is equal to the taper angle of the outer peripheral surface of the first projection portion 91. For example, in the modification example illustrated in FIG. 11, the outer periphery of the first projection portion 91 has a constricted shape, and an outer diameter R1′ in the axial direction of the first projection portion, that is, the central portion in the Z-axis direction is smaller than the outer diameter R1″ at both end portions in the axial direction.

As illustrated in FIG. 1, the wirings 731 to 733, 741 to 743, and 751 to 753 provided on the substrate 2 do not overlap the second projection portion 92 in plan view from the Z-axis direction. With this configuration, the wirings 731 to 733, 741 to 743, and 751 to 753 are not exposed in the second projection portion 92, and it is possible to effectively suppress the sealing member 63 scattered in the first projection portion 91 from adhering to the wirings 731 to 733, 741 to 743, and 751 to 753. For that reason, variation of the parasitic capacitance of the wirings 731 to 733, 741 to 743, and 751 to 753 due to the adhesion of the sealing member 63 can be effectively suppressed, and when the sealing member 63 has conductivity, short circuiting between the wirings can be effectively suppressed.

The inertial sensor 1 has been described as above. As described above, the inertial sensor 1 includes the substrate 2, the package 100 including the lid 6 bonded to the substrate 2 and having the internal space S between the substrate 2 and the lid 6, and the sensor elements 3, 4, and 5 accommodated in the space S. The lid 6 has the through-hole 62 that communicates with the inside and outside of the internal space S and is sealed by the sealing member 63. The inertial sensor 1 includes the cylindrical first projection portion 91 provided on the lid 6 and surrounding the lower opening 621 which is an opening on the inner space S side of the through-hole 62 in plan view from the Z-axis direction and the cylindrical second projection portion 92 provided on the substrate 2 and surrounding the outer periphery of the first projection portion 91 in plan view from the Z-axis direction. According to such a configuration, the first projection portion 91 and the second projection portion 92 can suppress scattering of the sealing member 63 into the internal space S. For that reason, the adhesion of the sealing member 63 to the sensor elements 3, 4, and 5 can be suppressed, and deterioration or variation of the drive characteristics of the sensor elements 3, 4, and 5 can be suppressed.

Also, as described above, the end portion of the first projection portion 91 on the substrate 2 side is inserted into the second projection portion 92. With this configuration, the gap G1 between the lower end surface 91b and the upper surface 2a can be surrounded by the second projection portion 92 over the entire circumference, and thus even if the sealing member 63 scatters outside the first projection portion 91 from the gap G1, further scattering of the sealing member 63 can be suppressed by the second projection portion 92 positioned on the outside of the first projection portion 91. As a result, the adhesion of the sealing member 63 to the sensor elements 3, 4, and 5 can be more effectively suppressed.

As described above, the first projection portion 91 is formed integrally with the lid 6. That is, the first projection portion 91 is integrated with the lid 6. With this configuration, formation of the first projection portion 91 becomes easy. A gap is not generated between the lid 6 and the first projection portion 91, and the scattering of the sealing member 63 outside the first projection portion 91 from the gap can be effectively suppressed.

As described above, the second projection portion 92 includes the same material as the sensor elements 3, 4, and 5, in the first embodiment, includes silicon. With this configuration, the second projection portion 92 and the sensor elements 3, 4, and 5 can be collectively formed from the silicon substrate 10. For that reason, formation of the second projection portion 92 becomes easy.

As described above, the inertial sensor 1 includes the wirings 731 to 733, 741 to 743, and 751 to 753 provided on the substrate 2 and electrically coupled to the sensor elements 3, 4, and 5. The wirings 731 to 733, 741 to 743, and 751 to 753 do not overlap the second projection portion 92 in plan view from the Z-axis direction. With this configuration, the wirings 731 to 733, 741 to 743, and 751 to 753 are not exposed in the second projection portion 92, and the adhesion of the sealing member 63 scattered in the first projection portion 91 to the wirings 731 to 733, 741 to 743, and 751 to 753 can be effectively suppressed. For that reason, variation of the parasitic capacitance of the wirings 731 to 733, 741 to 743, and 751 to 753 due to the adhesion of the sealing member 63 can be effectively suppressed, and when the sealing member 63 has conductivity, short circuiting between the wirings can be effectively suppressed.

### Second Embodiment

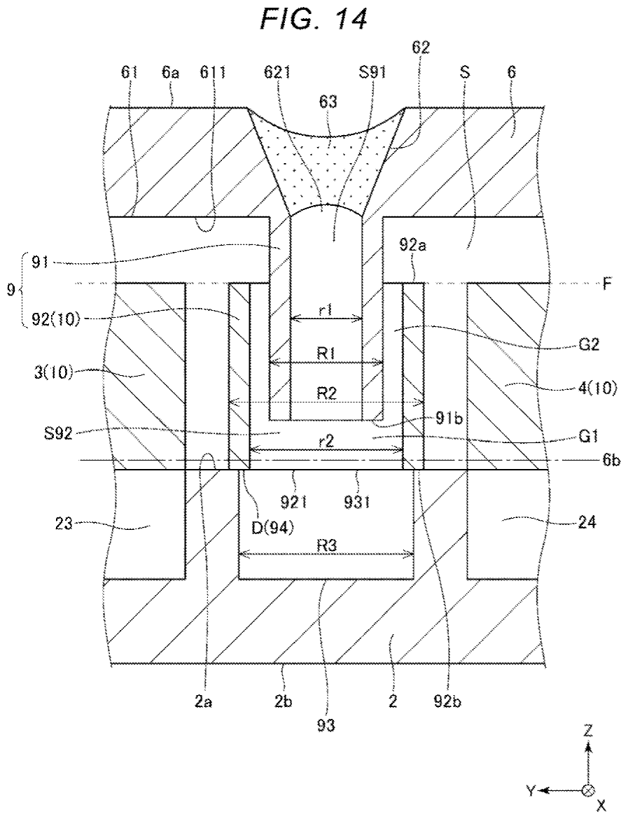

FIG. 14 is a cross-sectional view illustrating a foreign matter adhesion suppression unit included in the inertial sensor of a second embodiment.

The second embodiment is the same as the first embodiment described above except that the configuration of the foreign matter adhesion suppression unit 9 is different. In the following description, the second embodiment will be described with a focus on differences from the embodiment described above, and description of similar matters will be omitted. In FIG. 14, the same reference numerals are given to the same configurations as those in the embodiment described above.

As illustrated in FIG. 14, in addition to the first projection portion 91 and the second projection portion 92 described above, the foreign matter adhesion suppression unit 9 of the second embodiment further includes a concave portion 93 that opens to the upper surface 2a of the substrate 2 and communicates with the inner space S92 of the second projection portion 92. Such a concave portion 93 functions as a reservoir for the sealing member 63 scattered in the first projection portion 91. For that reason, it is possible to more effectively suppress the sealing member 63 from being scattered outside the second projection portion 92 from the gap G2 between the first projection portion 91 and the second projection portion 92. The shape of the concave portion 93 in plan view is a circle concentric with the second projection portion 92. However, the shape of the concave portion 93 in plan view is not particularly limited.

When the inner diameter of the second projection portion 92 is r2 and the outer diameter is R2, the diameter R3 of an opening 931 of the concave portion 93 is r2<R3<R2, and the lower opening 921 of the second projection portion 92 is positioned inside the opening 931 of the concave portion 93. For that reason, a step D constituted with the lower end surface 92b of the second projection portion 92 is formed between the inner peripheral surface of the second projection portion 92 and the inner peripheral surface of the concave portion 93. Due to this step D, a return portion 94 is formed, and the sealing member 63 that enters the concave portion 93 is less likely to be scattered outside the concave portion 93. For that reason, it is possible to further effectively suppress the sealing member 63 from being scattered outside the second projection portion 92 from the gap G2.

As such, in the inertial sensor 1 of the second embodiment, the substrate 2 includes the concave portion 93 that communicates with the inner space S92 of the second projection portion 92. Such a concave portion 93 functions as a reservoir for the sealing member 63 that scattered in the first projection portion 91, and it is possible to more effectively suppress the sealing member 63 from being scattered outside the second projection portion 92 from the gap G2.

As described above, the lower opening 921 is positioned inside the opening 931 of the concave portion 93 in plan view from the Z-axis direction. For that reason, the step D is formed between the inner peripheral surface of the second projection portion 92 and the inner peripheral surface of the concave portion 93, and the return portion 94 is formed by this step D. As a result, the sealing member 63 that has entered the concave portion 93 is less likely to be scattered outside the concave portion 93. For that reason, it is possible to more effectively suppress the sealing member 63 from being scattered outside the second projection portion 92 from the gap G2.

### Third Embodiment

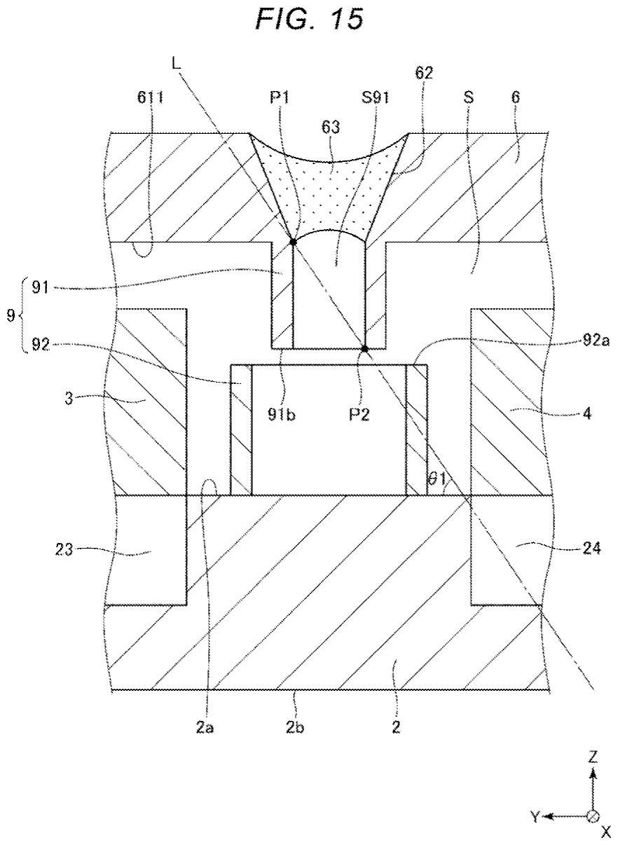

FIG. 15 is a cross-sectional view illustrating a foreign matter adhesion suppression unit included in an inertial sensor of a third embodiment.

The third embodiment is the same as the first embodiment described above except that the configuration of the foreign matter adhesion suppression unit 9 is different. In the following description, the third embodiment will be described with a focus on differences from the embodiments described above, and description of similar matters will be omitted. In FIG. 15, the same reference numerals are given to the same configurations as those in the embodiments described above.

As illustrated in FIG. 15, in the inertial sensor 1 of the third embodiment, the lower end surface 91b of the first projection portion 91 is positioned above the plane F, and the first projection portion 91 is not inserted into the inner space S92 of the second projection portion 92. Of the straight lines connecting two different points on the inner peripheral surface of the first projection portion 91, a straight line L having the smallest angle θ1 with respect to the upper surface 2a of the substrate 2 intersects the inner surface of the second projection portion 92. In the illustrated configuration, the straight line L connects a point P1 positioned on the plus side in the Y-axis direction of the upper end of the first projection portion 91 and a point P2 positioned at the minus side in the Y axis direction of the lower end of the first projection portion 91. The “inner surface of the second projection portion 92” includes the upper surface 2a of the substrate 2 exposed from the lower opening 921 of the second projection portion 92, in addition to the inner peripheral surface of the second projection portion 92.

It is considered that, when the sealing member 63 scatters linearly, the angle θ1 is the smallest in the scattering direction of the sealing member 63 along the straight line L. For that reason, if the straight line L intersects the inner surface of the second projection portion 92, the sealing member 63 scattered outside the first projection portion 91 adheres to the inner surface of the second projection portion 92, and scattering of the sealing member 63 to the outside of the second projection portion 92 can be suppressed.

As such, in the inertial sensor 1 of the third embodiment, of the straight lines connecting two different points on the inner peripheral surface of the first projection portion 91, the straight line L having the smallest angle θ1 with respect to the upper surface 2a which is the main surface of the substrate 2 intersects the inner surface of the second projection portion 92. With this configuration, the sealing member 63 scattered outside the first projection portion 91 adheres to the inner surface of the second projection portion 92, and scattering of the sealing member 63 to the outside of the second projection portion 92 can be suppressed.

### Fourth Embodiment

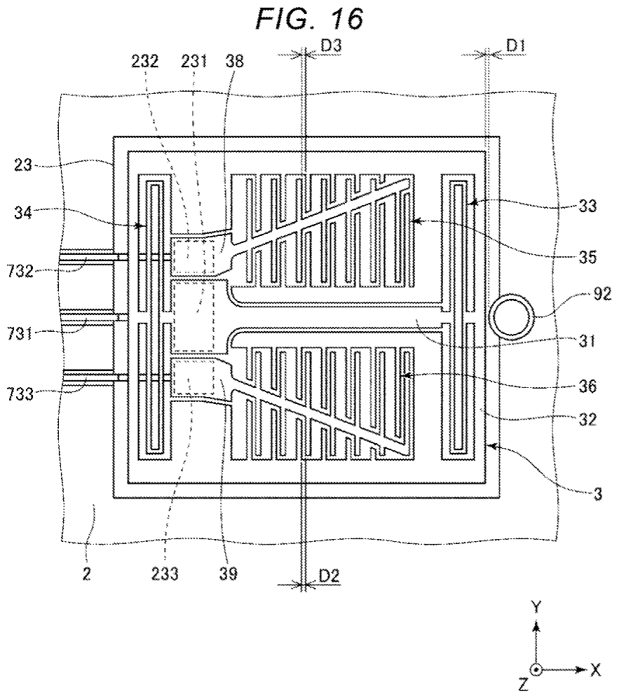

FIG. 16 is a plan view illustrating an inertial sensor of a fourth embodiment.

The fourth embodiment is the same as the first embodiment described above except that the second projection portion 92 functions as a stopper that restricts excessive displacement of the movable body 32 of the sensor element 3. In the following description, the fourth embodiment will be described with a focus on differences from the embodiments described above, and description of similar matters will be omitted. In FIG. 16, the same reference numerals are given to the same configurations as those in the embodiments described above.

As illustrated in FIG. 16, in the inertial sensor 1 of the fourth embodiment, the second projection portion 92 is positioned on the minus side in the X-axis direction of the sensor element 3. The second projection portion 92 is close to the sensor element 3 and the movable body 32 of the sensor element 3 and the second projection portion 92 face to each other. The distance D1 between the second projection portion 92 and the movable body 32 is smaller than the distance D2 between the first movable electrode 35 and the first fixed electrode 38 and the distance D3 between the second movable electrode 36 and the second fixed electrode 39. That is, D1<D2, and D1<D3. With this configuration, when a large acceleration in the X-axis direction is applied to the movable body 32 due to a strong impact or the like, the movable body 32 comes into contact with the second projection portion 92 before the first and second movable electrodes 35 and 36 and the first and second fixed electrodes 38 and 39 come into contact with each other, and displacement beyond contacting of the movable body 32 with the second projection portion 92 is regulated. For that reason, damage to the sensor element 3, in particular, the first and second movable electrodes 35 and 36 and the first and second fixed electrodes 38 and 39 can be effectively suppressed.

As such, in the inertial sensor 1 of the fourth embodiment, the sensor element 3 includes the movable body 32 that can be displaced with respect to the substrate 2, and the second projection portion 92 can contact the movable body 32. The movable body 32 is allowed to come into contact with the second projection portion 92, thereby regulating displacement beyond contacting of the movable body 32 with the second projection portion 92. For that reason, excessive displacement of the sensor element 3 can be regulated, and damage to the sensor element 3 can be effectively suppressed.

The second projection portion 92 of the fourth embodiment functions as a stopper that regulates excessive displacement of the movable body 32 of the sensor element 3, but is not limited thereto, and may function as a stopper that regulates excessive displacement of the movable body 42 of the sensor element 4, or may function as a stopper that regulates excessive displacement of each of the movable bodies 32 and 42.

### Fifth Embodiment

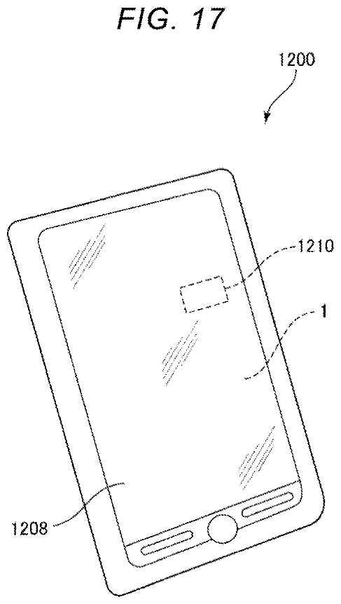

FIG. 17 is a plan view illustrating a smartphone of a fifth embodiment.

In the smartphone 1200 illustrated in FIG. 17, the inertial sensor 1 and a control circuit 1210 that performs control based on detection signals output from the inertial sensor 1 are incorporated. Detection data detected by the inertial sensor 1 is transmitted to the control circuit 1210, and the control circuit 1210 can recognize the attitude and behavior of the smartphone 1200 from the received detection data, change a display image displayed on a display unit 1208, generate an alarm sound or sound effect, or drive the vibration motor to vibrate the main body.

The smartphone 1200 as such an electronic apparatus includes the inertial sensor 1 and the control circuit 1210 that performs control based on a detection signal output from the inertial sensor 1. For that reason, the effect of the inertial sensor 1 described above can be obtained and high reliability can be exhibited.

The electronic apparatus incorporating the inertial sensor 1 is not particularly limited, and includes, for example, a personal computer, a digital still camera, a tablet terminal, a timepiece, a smartphone, an ink jet printer, a laptop personal computer, a TV, a wearable terminals such as HMD (head mounted display), a video camera, a video tape recorder, a car navigation device, a pager, an electronic datebook, an electronic dictionary, a calculator, an electronic game machines, a word processor, a work station, a videophone, a security TV monitor, electronic binoculars, a POS terminal, medical equipment, a fish finder, various measuring instruments, mobile terminal base station equipment, various instruments of vehicles, aircraft, and ships, a flight simulator, a network server, and the like, in addition to the smartphone 1200.

### Sixth Embodiment

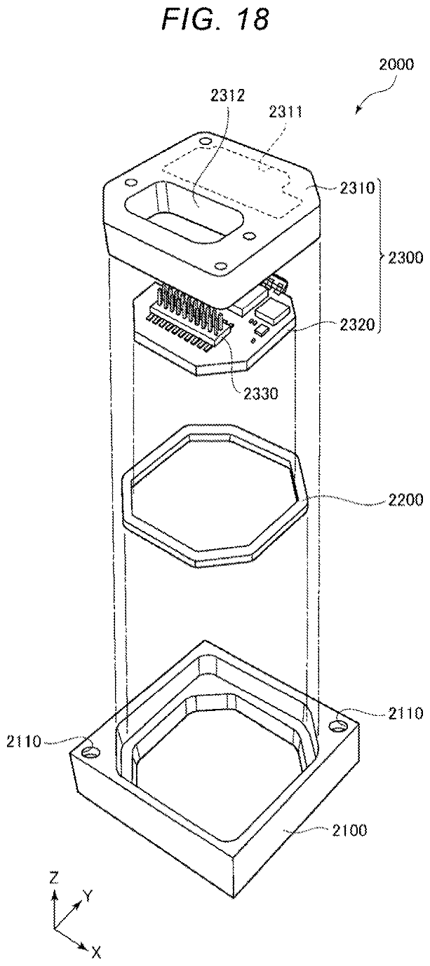

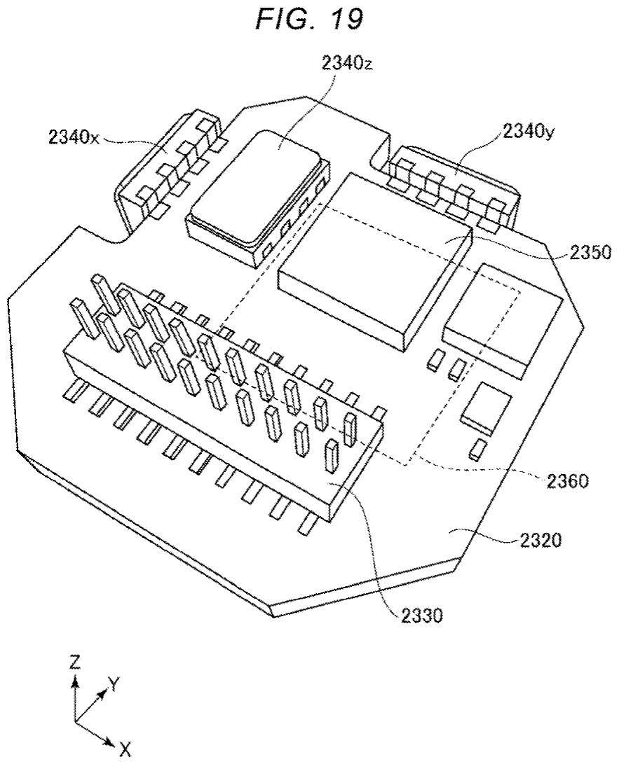

FIG. 18 is an exploded perspective view illustrating an inertia measurement device according to a sixth embodiment. FIG. 19 is a perspective view of a substrate included in the inertia measurement device illustrated in FIG. 18.

An inertia measurement device 2000 (IMU: Inertial measurement Unit) illustrated in FIG. 18 is an inertia measurement device that detects the attitude and behavior of amounted device such as an automobile or a robot. The inertia measurement device 2000 functions as a six-axis motion sensor including three-axis acceleration sensors and three-axis angular velocity sensors.

The inertia measurement device 2000 is a rectangular parallelepiped having a substantially square planar shape. Screw holes 2110 as fixed portions are formed in the vicinity of two vertices positioned in the diagonal direction of the square. Through two screws in the two screw holes 2110, the inertia measurement device 2000 can be fixed to the mounted surface of the mounted object such as an automobile. The size of the inertia measurement device 2000 can be reduced such that the device can be mounted on a smartphone or a digital still camera, for example, by selection of parts or design change.

The inertia measurement device 2000 has a configuration in which an outer case 2100, a bonding member 2200, and a sensor module 2300 are included and the sensor module 2300 is inserted in the outer case 2100 with the bonding member 2200 interposed therebetween. Similarly to the overall shape of the inertia measurement device 2000 described above, the outer shape of the outer case 2100 is a rectangular parallelepiped having a substantially square planar shape, and screw holes 2110 are formed in the vicinity of two vertices positioned in the diagonal direction of the square. In addition, the outer case 2100 has a box shape and the sensor module 2300 is accommodated therein.

Further, the sensor module 2300 includes an inner case 2310 and a substrate 2320. The inner case 2310 is a member for supporting the substrate 2320, and has a shape that fits inside the outer case 2100. A concave portion 2311 for suppressing contact with the substrate 2320 and an opening 2312 for exposing a connector 2330 described later are formed in the inner case 2310. Such an inner case 2310 is bonded to the outer case 2100 through the bonding member 2200. The substrate 2320 is bonded to the lower surface of the inner case 2310 through an adhesive.

As illustrated in FIG. 19, a connector 2330, an angular velocity sensor 2340z for measuring the angular velocity around the Z-axis, an acceleration sensor 2350 for measuring acceleration in each axis direction of the X-axis, the Y-axis, and the Z-axis and the like are mounted on the upper surface of the substrate 2320. An angular velocity sensor 2340x for measuring the angular velocity around the X-axis and an angular velocity sensor 2340y for measuring the angular velocity around the Y-axis are mounted on the side surface of the substrate 2320. As these sensors, the inertial sensor of the embodiments can be used.

A control IC 2360 is mounted on the lower surface of the substrate 2320. The control IC 2360 is a micro controller unit (MCU) and controls each unit of the inertia measurement device 2000. In the storing unit, programs defining the order and contents for measuring the acceleration and angular velocity, programs for digitizing detected data and incorporating the detected data into packet data, accompanying data, and the like are stored. In addition, a plurality of electronic components are mounted on the substrate 2320.

### Seventh Embodiment

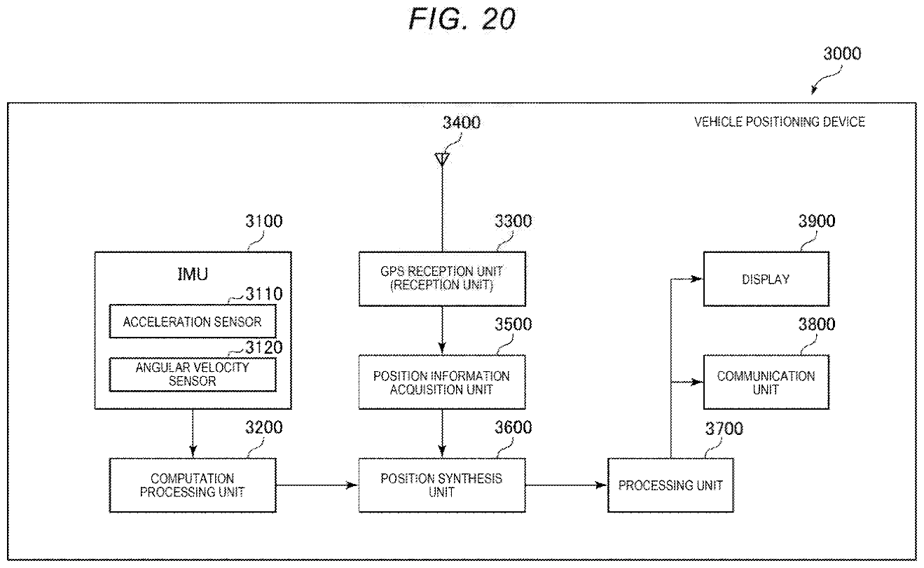

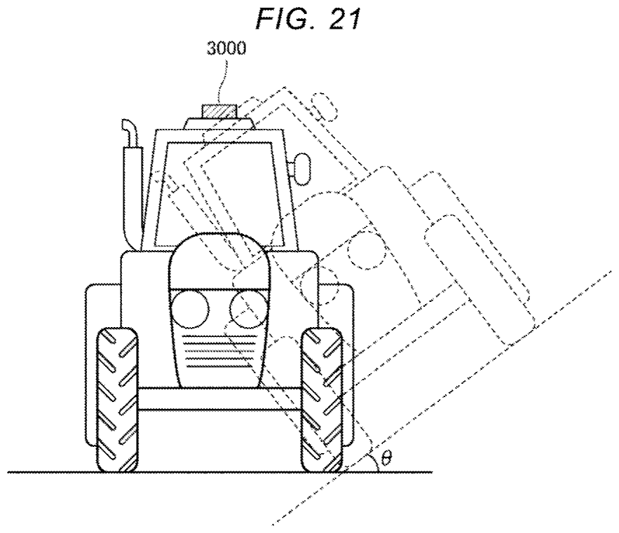

FIG. 20 is a block diagram illustrating the entire system of a vehicle positioning device according to a seventh embodiment. FIG. 21 is a diagram illustrating the operation of the vehicle positioning device illustrated in FIG. 20.

A vehicle positioning device 3000 illustrated in FIG. 20 is a device which is used by being mounted on a vehicle and performs positioning of the vehicle. The vehicle is not particularly limited, and may be any of a bicycle, an automobile, a motorcycle, a train, an airplane, a ship, and the like, but in the seventh embodiment, description will be made on a four-wheeled automobile as the vehicle.

The vehicle positioning device 3000 includes an inertia measurement device 3100 (IMU), a computation processing unit 3200, a GPS reception unit 3300, a receiving antenna 3400, a position information acquisition unit 3500, a position synthesis unit 3600, a processing unit 3700, a communication unit 3800, and a display 3900. As the inertia measurement device 3100, for example, the inertia measurement device 2000 described above can be used.

The inertia measurement device 3100 includes a tri-axis acceleration sensor 3110 and a tri-axis angular velocity sensor 3120. The computation processing unit 3200 receives acceleration data from the acceleration sensor 3110 and angular velocity data from the angular velocity sensor 3120, performs inertial navigation computation processing on these data, and outputs inertial navigation positioning data including acceleration and attitude of the vehicle.

The GPS reception unit 3300 receives a signal from the GPS satellite through the receiving antenna 3400. Further, the position information acquisition unit 3500 outputs GPS positioning data representing the position (latitude, longitude, altitude), speed, direction of the vehicle positioning device 3000 based on the signal received by the GPS reception unit 3300. The GPS positioning data also includes status data indicating a reception state, a reception time, and the like.

Based on inertial navigation positioning data output from the computation processing unit 3200 and the GPS positioning data output from the position information acquisition unit 3500, the position synthesis unit 3600 calculates the position of the vehicle, more specifically, the position on the ground where the vehicle is traveling. For example, even if the position of the vehicle included in the GPS positioning data is the same, as illustrated in FIG. 21, if the attitude of the vehicle is different due to the influence of inclination θ of the ground or the like, the vehicle is traveling at different positions on the ground. For that reason, it is impossible to calculate an accurate position of the vehicle with only GPS positioning data. Therefore, the position synthesis unit 3600 calculates the position on the ground where the vehicle is traveling, using inertial navigation positioning data.

The position data output from the position synthesis unit 3600 is subjected to predetermined processing by the processing unit 3700 and displayed on the display 3900 as a positioning result. Further, the position data may be transmitted to the external apparatus by the communication unit 3800.

### Eighth Embodiment

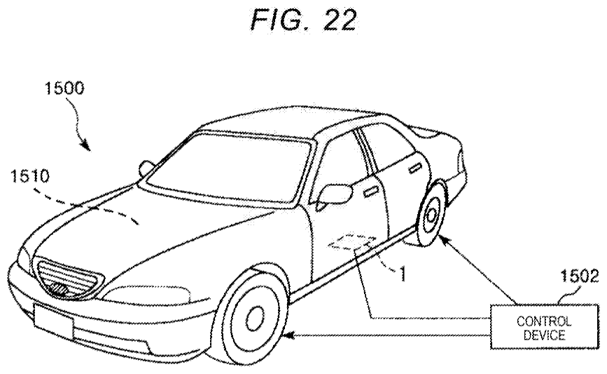

FIG. 22 is a perspective view illustrating a vehicle according to an eighth embodiment of the disclosure.

An automobile 1500 as the vehicle illustrated in FIG. 22 includes at least one system 1510 of an engine system, a brake system, and a keyless entry system. The inertial sensor 1 is incorporated in the automobile 1500, and the attitude of the vehicle body can be measured by the inertial sensor 1. The detection signal of the inertial sensor 1 is supplied to the control device 1502, and the control device 1502 can control the system 1510 based on the signal.

As such, the automobile 1500 as the vehicle includes the inertial sensor 1 and the control device 1502 that performs control based on the detection signal output from the inertial sensor 1. For that reason, the effect of the inertial sensor 1 described above can be obtained and high reliability can be exhibited.

In addition, the inertial sensor 1 can also be widely applied to a car navigation system, a car air conditioner, an anti-lock braking system (ABS), an air bag, a tire pressure monitoring system (TPMS), an engine controller, and an electronic control unit (ECU) such as a battery monitor of a hybrid car or an electric automobile. Also, the vehicle is not limited to the automobile 1500, but can also be applied to an airplane, a rocket, a satellite, a ship, an automated guided vehicle (AGV), a biped walking robot, an unmanned airplane such as a drone, and the like.

Although the inertial sensor according to the present disclosure, the electronic apparatus, and the vehicle according to the present disclosure have been described based on the embodiments, the disclosure is not limited thereto. The configuration of each unit can be replaced with any configuration having the same function. In the embodiments described above, the configuration in which the sensor element measures acceleration is described, but is not limited thereto, and for example, a configuration in which angular velocity is detected may be adopted.

What is claimed is:

1. An inertial sensor comprising:
a package that includes a substrate and a lid bonded to the substrate and has an internal space between the substrate and the lid; and
a sensor element accommodated in the internal space, wherein
the lid has a through-hole causing an inside and an outside of the internal space to communicate with each other and sealed with a sealing member, and
the inertial sensor further comprises
a cylindrical first projection portion provided on the lid and surrounding an opening of the through-hole at the internal space side in plan view, and
a cylindrical second projection portion provided on the substrate and surrounding an outer periphery of the first projection portion in plan view.

2. The inertial sensor according to claim 1, wherein
an end portion of the first projection portion at the substrate side is inserted into the second projection portion.

3. The inertial sensor according to claim 1, wherein
the first projection portion is integrated with the lid.

4. The inertial sensor according to claim 1, wherein
the second projection portion contains the same material as the sensor element.

5. The inertial sensor according to claim 1, wherein
among straight lines connecting two different points on an inner peripheral surface of the first projection portion, a straight line having a smallest angle with respect to a main surface of the substrate intersects an inner surface of the second projection portion.

6. The inertial sensor according to claim 1, wherein
the substrate has a concave portion communicating with an inner space of the second projection portion.

7. The inertial sensor according to claim 6, wherein
in plan view, the opening is positioned inside an opening of the concave portion.

8. The inertial sensor according to claim 1, wherein
the sensor element includes a movable body configured to be displaced with respect to the substrate, and
the second projection portion is configured to contact the movable body.

9. The inertial sensor according to claim 1, further comprising:
a wiring provided on the substrate and electrically coupled to the sensor element, wherein
the wiring does not overlap the second projection portion in plan view.

10. An electronic apparatus comprising:
the inertial sensor according to claim 1; and
a control circuit that performs control based on a detection signal output from the inertial sensor.

11. A vehicle comprising:
the inertial sensor according to claim 1; and
a control device that performs control based on a detection signal output from the inertial sensor.
